(19) United States
(12) Patent Application Publication
(10) Pub. No.: US 2025/0224303 A1
(43) Pub. Date: Jul. 10, 2025

(54) BACKFLOW LEAK SENSOR DEFLECTOR

(71) Applicant: WATTS REGULATOR CO., North Andover, MA (US)

(72) Inventor: Steven Castrigno, Chester, NH (US)

(21) Appl. No.: 19/013,733

(22) Filed: Jan. 8, 2025

Related U.S. Application Data
(60) Provisional application No. 63/619,644, filed on Jan. 10, 2024.

(51) Int. Cl. G01M 3/28

(52) U.S. Cl. CPC G01M 3/2876

(57) ABSTRACT

A fluid deflector for a plumbing fixture includes a fluid deflecting element, and one or more arm members the fluid deflecting element to suspend the fluid deflecting element within a fluid flow opening associated with the plumbing fixture. The fluid deflecting element to deflect fluid toward one or more fluid sensors associated with the plumbing fixture.

### CROSS REFERENCE TO RELATED APPLICATIONS

This application claims the benefit of U.S. Provisional Patent Application No. 63/619,644, filed Jan. 10, 2024, which is fully incorporated herein by reference.

### TECHNICAL FIELD

The present disclosure is generally directed to plumbing equipment, and, more particularly, to a backflow leak sensor deflector.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates is a perspective view of a backflow valve according to one embodiment of the present disclosure;

FIG. 2 illustrates a perspective exploded view of a deflector and leak sensor module for use with the backflow valve of FIG. 1 according to one embodiment of the present disclosure;

FIG. 3 illustrates a perspective view of the assembled deflector and leak sensor module of FIG. 1;

FIG. 4 illustrates a cross-sectional view of the assembled deflector and leak sensor module of FIG. 2, taken along lines X-X;

FIG. 5 illustrates a top perspective view of the deflector of FIG. 2;

FIG. 6 illustrates a bottom perspective view of the deflector of FIG. 2;

FIG. 7 illustrates a top down view of the deflector of FIG. 2;

FIG. 8 illustrates a cross-sectional view of the deflector of FIG. 7, taken along lines XI-XI;

FIG. 9 illustrates a cross-sectional view of the deflector of FIG. 7, taken along lines XII-XII;

FIG. 10 illustrates a perspective view of a backflow valve according to another embodiment of the present disclosure;

FIG. 11 illustrates a perspective view of a deflector and leak sensor module for use with the backflow valve of FIG. 10 according to one embodiment of the present disclosure;

FIG. 12 illustrates a perspective view of the assembled deflector and leak sensor module of FIG. 10;

FIG. 13 illustrates a cross-sectional view of the assembled deflector and leak sensor module of FIG. 3, taken along lines XIII-XIII;

FIG. 14 illustrates a top perspective view of the deflector of FIG. 11;

FIG. 15 illustrates a bottom perspective view of the deflector of FIG. 11;

FIG. 16 illustrates a top down view of the deflector of FIG. 11;

FIG. 17 illustrates a cross-sectional view of the deflector of FIG. 16, taken along lines XIV-XIV; and

FIG. 18 illustrates a generalized valve and deflector arrangement according to embodiments of the present disclosure.

Although the following Detailed Description will proceed with reference being made to illustrative embodiments, many alternatives, modifications and variations thereof will be apparent to those skilled in the art.

### DETAILED DESCRIPTION

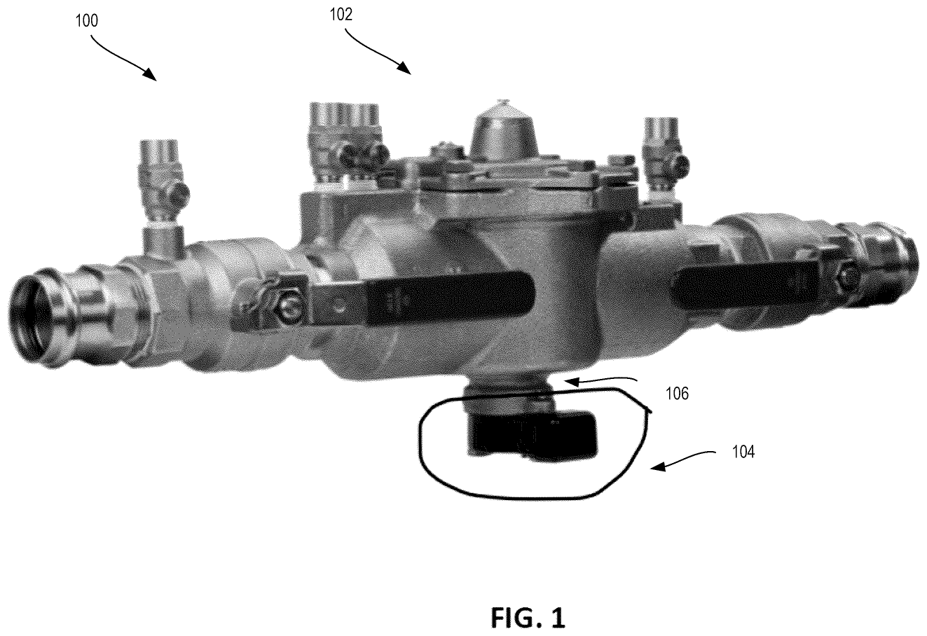

FIG. 1 illustrates is a perspective view of a backflow valve 100 according to one embodiment of the present disclosure. The backflow valve 100 generally includes a main body portion 102 generally configured to prevent fluid backflow through the main body 102, and a leak sensor module 104 generally configured to detect a fluid leak and/or fluid flow through the main body 102. The leak sensor module 104 is coupled to an underside of the main body around a fitting region 106, and the leak sensor module 104 includes one or more fluid sensors (not shown in this figure) to detect the present of fluid that may be flowing or dripping through the collar region 106. As a general matter, the presence of fluid through the fitting region 106 indicates that the backflow valve is in need of repair and/or replacement. The backflow valve 100 including the mechanical structures of the main body 102 and the electronic components of the leak sensor module 104 are described in detail in U.S. patent application Ser. No. 18/265,934, filed Jun. 7, 2023, assigned to Watts Regulator Co., which is hereby incorporated by reference in its entirety.

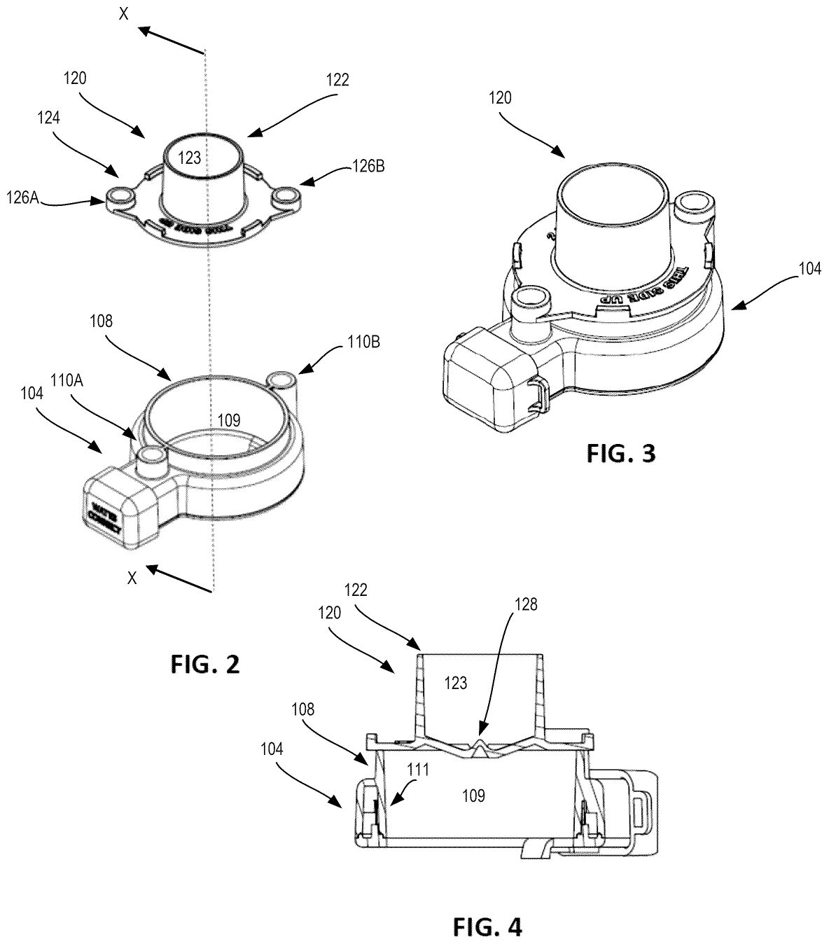

FIG. 2 illustrates a perspective exploded view of a deflector 120 and leak sensor module 104 for use with the backflow valve of FIG. 1 according to embodiments of the present disclosure. In some embodiments, the deflector 120 may be formed as a separate unit from the leak sensor module 104 to permit, for example, after-market retrofitting of the leak sensor module 104 with an appropriately-sized deflector 120. In other embodiments, the deflector 120 and leak sensor module 104 may formed as an integrated unit. The leak sensor module 104 includes an annular portion 108 defining an orifice 109. Within the orifice 109 (along the inner wall of the annular portion 108), one or more fluid sensors (not shown) are disposed to detect the presence of fluid flowing through the annular portion 108. The leak sensor module 104 also defines one or more fastening openings 110A and 110B to fasten the deflector 120 to the leak detector module 104.

The deflector 120 includes a collar portion 122 defining an orifice 123. The collar portion 122 is generally dimensioned to mate with the fitting region 106 of the main body 102 (FIG. 1). The deflector 120 also includes a flange portion 124 at least partially surrounding the collar portion 122. The flange portion 124 includes one or more fastening openings 126A and 126B dimensioned to mate with fastening openings 110A and 110B to secure the deflector 120 to the top of the leak sensor module 104, as shown in the assembled perspective view of FIG. 3. When assembled, the opening 123 of the deflector 120 is generally aligned with the opening 109 of the leak sensor module 104. The deflector 120 may be fastened to the leak sensor modules 104 using, for example, screws, pins, etc., via aligned fastening openings 126A and 126B and fastening opening 110A and 110B. In some embodiments, the size (e.g., diameter) of opening 123 is less than the size (e.g., (diameter) of the opening 109.

FIG. 4 illustrates a cross-sectional view of the assembled deflector and leak sensor module of FIG. 2, taken along lines X-X. As illustrated in cross section, the deflector 120 includes a deflecting element 128 disposed within the opening 128 of collar 122. The deflector element 128 is generally configured to cause fluid flow within the opening 123 to project onto an inner sidewall 111 of the annular portion 108 of the leak sensor module 104. As noted above, one or more fluid sensors are disposed around the periphery of the inner sidewall 111. By deflecting fluid onto the inner sidewall 111 via the deflecting element 128, a more accurate and consistent sensing of fluid flow within openings 123/109 may be achieved. This is particularly true with low fluid flow (e.g., drip) within the opening 123/109.

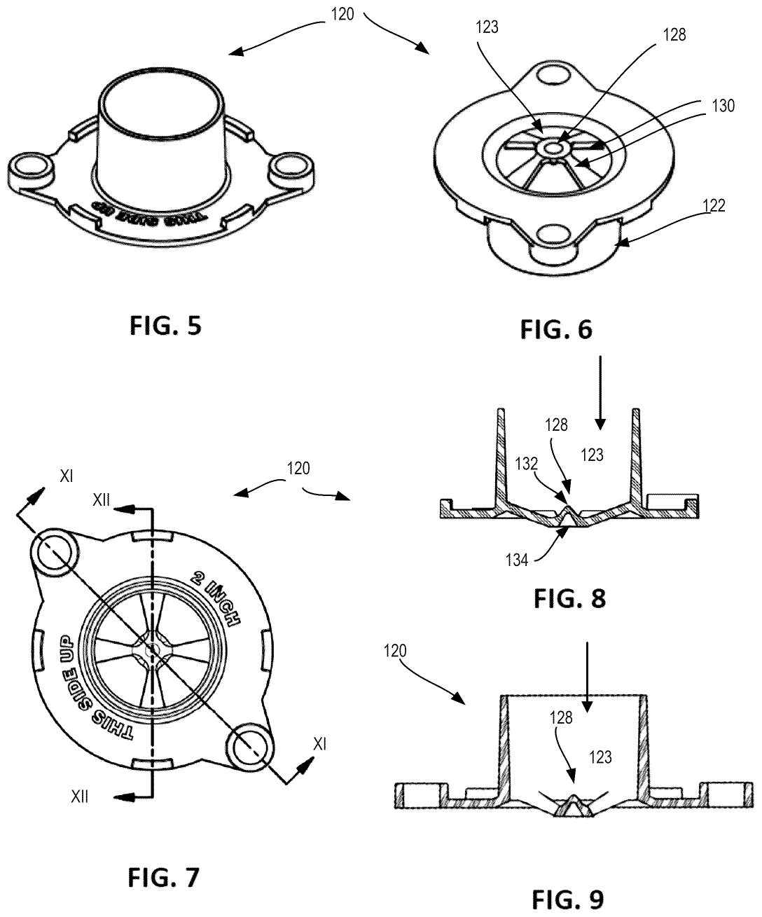

FIG. 5 illustrates a top perspective view of the deflector of FIG. 2 and FIG. 6 illustrates a bottom perspective view of the deflector of FIG. 2. As shown in FIG. 6, the deflecting element 128 may be disposed generally in the center of opening 123. One or more arm members 130 are disposed on the inner surface of the collar region 122 and coupled to the deflecting element 128 to hold the deflecting element in position and within fluid flow through the opening 123. The deflecting element 128 may be disposed at a position within the collar 122 that is nearest to the opening 109, so that deflection of fluid off of the deflecting member 128 has a greater chance/opportunity of reaching the inner sidewall 111 of opening 109, thus increasing the opportunity of the sensor(s) to detect fluid flow.

FIG. 7 illustrates a top down view of the deflector of FIG. 2, FIG. 8 illustrates a cross-sectional view of the deflector of FIG. 7, taken along lines XI-XI, and FIG. 9 illustrates a cross-sectional view of the deflector of FIG. 7, taken along lines XII-XII. As illustrated in FIG. 8, in some embodiments the deflecting element 128 is generally dimensioned as having a triangular or conical cross section with a tip portion 132 and a base portion 134, with the tip portion 132 of the triangle or cone pointing towards a fluid flow through the opening 123 (as indicated by the downward arrow). In other embodiments, the deflecting element 128 may include other shapes such as a pyramid, cylinder with rounder tip portion, etc. As a general matter, and as described herein, the shape of the deflecting element 128 is generally configured to cause fluid to project away from the center region of the opening 123 and toward the sidewalls of the opening 123. The overall size of the deflecting element 128 may be selected based on, for example, expected fluid flow within the opening 123, overall size of the opening 123, etc.

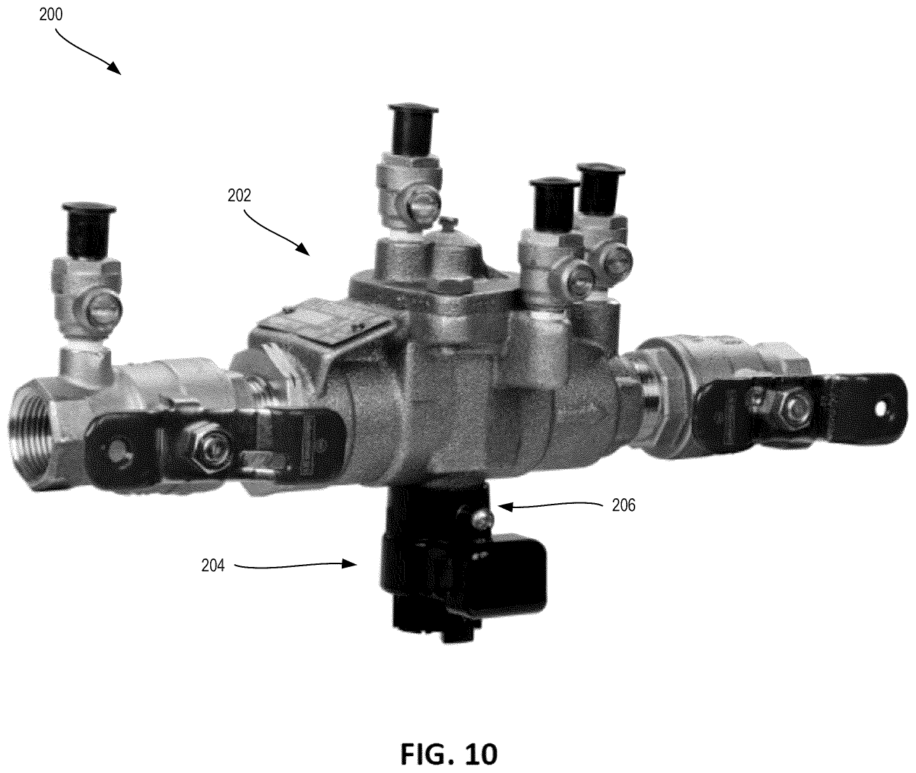

FIG. 10 illustrates is a perspective view of a backflow valve 100 according to another embodiment of the present disclosure. The backflow valve 200 of this embodiment is similar to the backflow valve 100 of FIG. 1, and generally includes a main body portion 202 generally configured to prevent fluid backflow through the main body 202, and a leak sensor module 204 generally configured to detect a fluid leak and/or fluid flow through the main body 202.

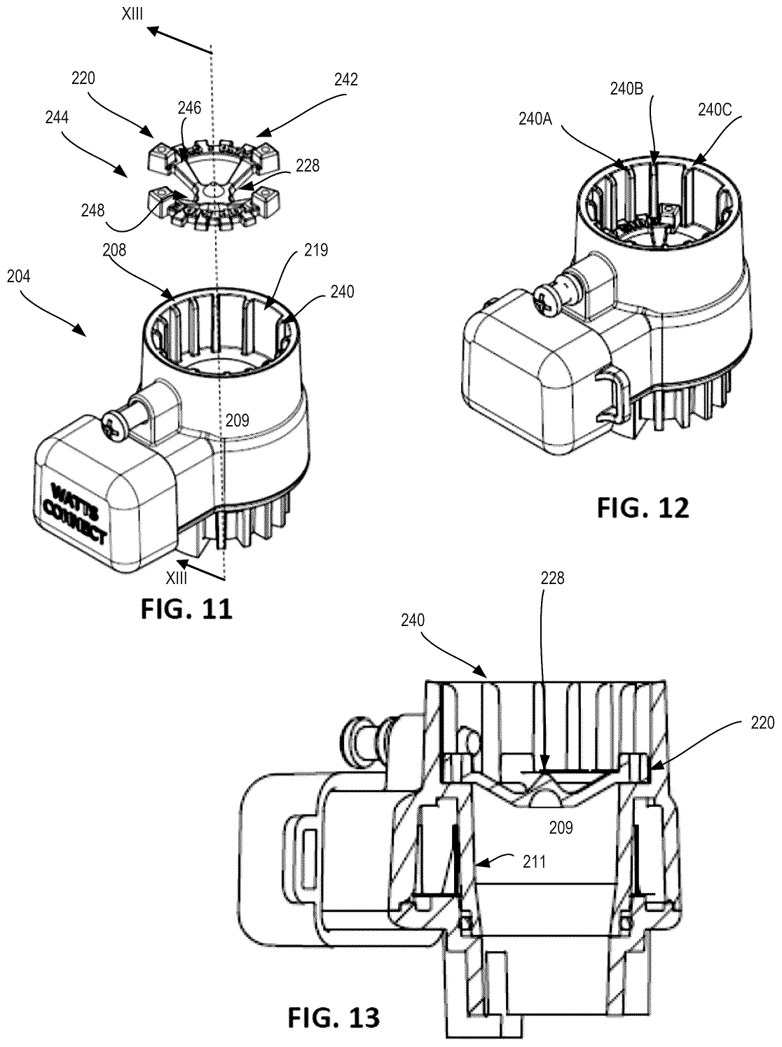

FIG. 11 illustrates a perspective exploded view of a deflector 220 and leak sensor module 204 for use with the backflow valve of FIG. 10 according to embodiments of the present disclosure. In some embodiments, the deflector 220 may be formed as a separate unit from the leak sensor module 204 to permit, for example, after-market retrofitting of the leak sensor module 204 with an appropriately-sized deflector 220. In other embodiments, the deflector 220 and leak sensor module 204 may formed as an integrated unit. The leak sensor module 104 includes an annular portion 208 defining an orifice 209. Within the orifice 209 (along the inner wall 219 of the annular portion 208), one or more fluid sensors (not shown) are disposed to detect the presence of fluid flowing through the annular portion 208. One or more slots or protrusions 240 are formed vertically along the inner wall 219.

The deflector 220 includes a deflecting element 228 and two peripheral lobes 242 and 244, where each lobe 242 and 244 forms arcuate shape along the outer edge thereof and generally dimensioned to fit within opening 209. The peripheral lobes 242 and 244 each include one or more arm members 246 and 248 to couple each respective lobe to the deflecting element 228. In some embodiments, the deflector element 228 is centered between lobes 242, 244 via one or more arms 246, 248 so that the deflector element 220 is centered within the opening 209. As described below, the lobes 242, 244 include features to mate with the slots/protrusion 240, to enable the deflector 220 to slide into the opening 209, as shown in the assembled perspective view of FIG. 12. In some embodiments, a plurality of slots/protrusions 240A, 240B, 240C, etc. may be formed around the periphery of the inner surface 219. In still other embodiments, the spacing between the plurality of slots/protrusions 240A, 240B, 240C, etc. may be different, for example, the spacing between slot/protrusion 240A, 240B is less than a spacing between slot/protrusion 240B, 240C, depending on the configuration of the lobes 242, 244 as described below.

FIG. 13 illustrates a cross-sectional view of the assembled deflector and leak sensor module of FIG. 11, taken along lines XIII-XIII, and shows the deflector 220 inserted into the opening 209 and engaged by protrusions 240. The deflector element 228 is generally configured to cause fluid flow within the opening 209 to project onto an inner sidewall 211 of the leak sensor module 204. As noted above, one or more fluid sensors are disposed around the periphery of the inner sidewall 211. By deflecting fluid onto the inner sidewall 211 via the deflecting element 228, a more accurate and consistent sensing of fluid flow within openings 209 may be achieved. This is particularly true with low fluid flow (e.g., drip) within the opening 209.

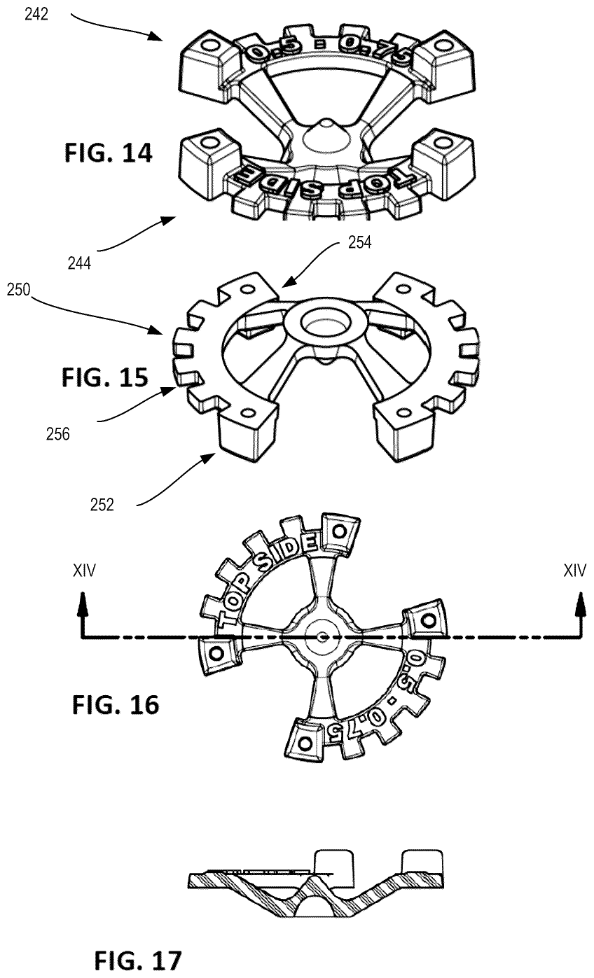

FIG. 14 illustrates a top perspective view of the deflector of FIG. 11, FIG. 15 illustrates a bottom perspective view of the deflector of FIG. 11, FIG. 16 illustrates a top down view of the deflector of FIG. 11, and FIG. 17 illustrates a cross-sectional view of the deflector of FIG. 16, taken along lines XIV-XIV. As a illustrates, the lobes 242 and 244 may each include a plurality of tongue (250) and groove (256) members to mate with slots/protrusions 240 to enable the deflector 220 to slid into the opening 209 and be held in place. In some embodiments, larger (wider) tongue members 252, 254 may be included, depending on the spacing of the slots/protrusions 240. at either end of the lobes 242 and 244.

As with the previous embodiment, the deflecting element 228 is generally dimensioned as having a triangular or conical cross section with a tip portion and a base portion, with the tip portion of the triangle or cone pointing towards a fluid flow through the opening 209. In other embodiments, the deflecting element 228 may include other shapes such as a pyramid, cylinder with rounder tip portion, etc. As a general matter, and as described herein, the shape of the deflecting element 228 is generally configured to cause fluid to project away from the center region of the opening 209 and toward the sidewalls of the opening 209. The overall size of the deflecting element 228 may be selected based on, for example, expected fluid flow within the opening 209, overall size of the opening 209, etc.

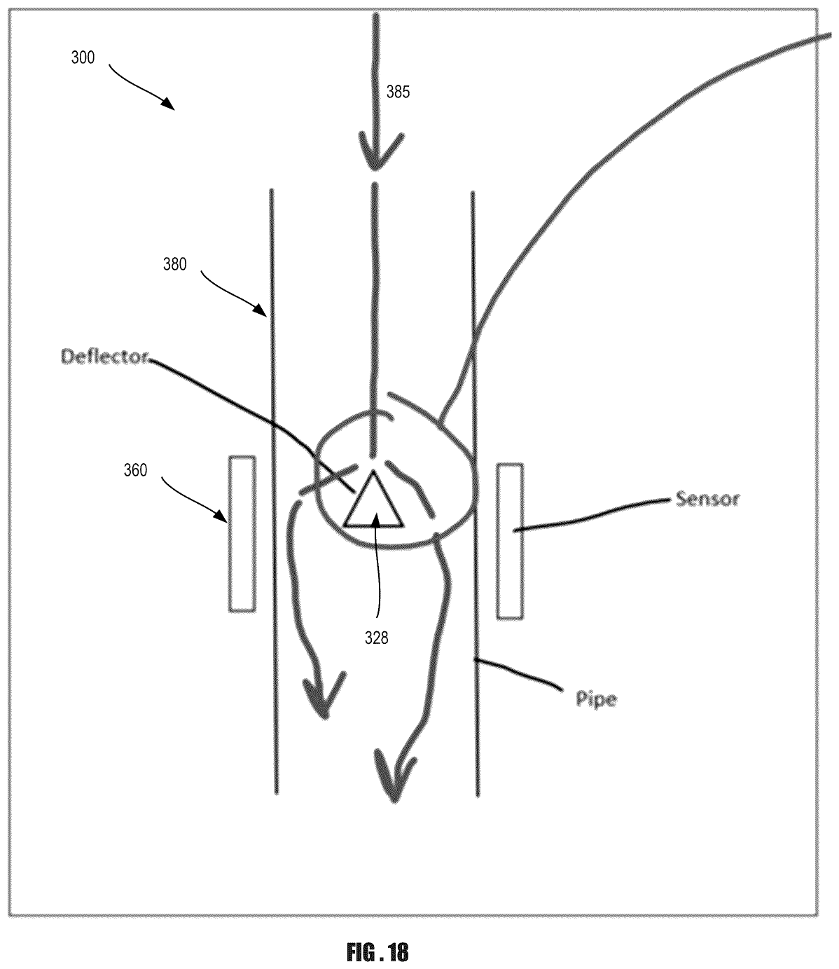

FIG. 18 illustrates a generalized valve and deflector arrangement 300 according to embodiments of the present disclosure. As a general matter, the teaching of the present disclosure provides a fluid deflector 328 disposed within a fluid conduit (e.g., pipe 380, etc.) within a fluid flow 385 to deflect fluid flow away from a center region of the conduit 380 and toward one or more fluid sensors 360.

Accordingly, in one embodiment the present disclosure provides a fluid deflector for a leak detection module. The fluid deflector includes a collar portion defining an opening; a fluid deflecting element; and one or more arm members coupled to an inner surface of the collar portion and coupled to the fluid deflecting element to suspend the fluid deflecting element within the opening; the fluid deflecting element to deflect fluid toward one or more fluid sensors associated with the leak detection module.

In another embodiment, the present disclosure provides a fluid deflector for a leak detection module. The fluid deflector includes a fluid deflecting element; a first lobe member coupled to the fluid deflecting element, the first lobe member having an arcuate shape corresponding to a fluid flow opening associated with the leak detection module; and a second lobe member coupled to the fluid deflecting element, the second lobe member having an arcuate shape corresponding to the fluid flow opening associated with the leak detection module. The first and second lobe members to suspend the fluid deflecting element within the opening; the fluid deflecting element to deflect fluid toward one or more fluid sensors associated with the leak detection module.

In yet another embodiment, the present disclosure provides a fluid deflector for a plumbing fixture. The fluid deflector includes a fluid deflecting element, one or more arm members coupled to the fluid deflecting element to suspend the fluid deflecting element within a fluid flow opening associated with the plumbing fixture. The fluid deflecting element to deflect fluid toward one or more fluid sensors associated with the plumbing fixture.

As used herein, the terms “side”, “front”, “back”, etc. are provided as a descriptive aid, not as a limitation or specific orientation. While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A fluid deflector for a leak detection module, comprising:
a collar portion defining an opening;
a fluid deflecting element; and
one or more arm members coupled to an inner surface of the collar portion and coupled to the fluid deflecting element to suspend the fluid deflecting element within the opening;
the fluid deflecting element to deflect fluid toward one or more fluid sensors associated with the leak detection module.

2. The fluid deflector of claim 1, wherein the fluid deflecting element having a generally conical cross-sectional shape, with a tip region pointing towards a fluid flow within the opening.

3. The fluid deflector of claim 1, wherein the fluid deflecting element having a generally pyramid cross-sectional shape, with a tip region pointing towards a fluid flow within the opening.

4. The fluid deflector of claim 1, wherein the fluid deflecting element being suspended adjacent to the one or more fluid sensors disposed within the opening.

5. The fluid deflector of claim 1, wherein the fluid deflecting element having an overall size based, at least in part, on a size of the opening.

6. The fluid deflector of claim 1, wherein the fluid deflecting element having an overall size based, at least in part, on an expected fluid flow within the opening.

7. The fluid deflector of claim 1, wherein the fluid deflecting element being suspended approximately in the center of the opening.

8. A fluid deflector for a leak detection module, comprising:
a fluid deflecting element;
a first lobe member coupled to the fluid deflecting element, the first lobe member having an arcuate shape corresponding to a fluid flow opening associated with the leak detection module; and
a second lobe member coupled to the fluid deflecting element, the second lobe member having an arcuate shape corresponding to the fluid flow opening associated with the leak detection module; wherein
the first and second lobe members to suspend the fluid deflecting element within the opening;
the fluid deflecting element to deflect fluid toward one or more fluid sensors associated with the leak detection module.

9. The fluid deflector of claim 8, wherein the fluid deflecting element having a generally conical cross-sectional shape, with a tip region pointing towards a fluid flow within the opening.

10. The fluid deflector of claim 8, wherein the fluid deflecting element having a generally pyramid cross-sectional shape, with a tip region pointing towards a fluid flow within the opening.

11. The fluid deflector of claim 8, wherein the fluid deflecting element being suspended adjacent to one or more fluid sensors disposed within the opening.

12. The fluid deflector of claim 8, wherein the fluid deflecting element having an overall size based, at least in part, on a size of the opening.

13. The fluid deflector of claim 8, wherein the fluid deflecting element having an overall size based, at least in part, on an expected fluid flow within the opening.

14. The fluid deflector of claim 8, wherein the fluid deflecting element being suspended approximately in the center of the opening.

15. The fluid deflector of claim 8, wherein the first lobe member including a first plurality of tongue and groove members disposed along the periphery of the arcuate shape; the first plurality of tongue and groove members being dimensioned to mate with a plurality of slots/protrusions disposed along an inner surface of the opening.

16. The fluid deflector of claim 8, wherein the second lobe member including a second plurality of tongue and groove members disposed along the periphery of the arcuate shape; the second plurality of tongue and groove members being dimensioned to mate with a plurality of slots/protrusions disposed along an inner surface of the opening.

17. A fluid deflector for a plumbing fixture, comprising:
a fluid deflecting element; and
one or more arm members coupled to the fluid deflecting element to suspend the fluid deflecting element within a fluid flow opening associated with the plumbing fixture;
the fluid deflecting element to deflect fluid toward one or more fluid sensors associated with the plumbing fixture.

18. The fluid deflector of claim 17, wherein the fluid deflecting element having a generally conical cross-sectional shape, with a tip region pointing towards a fluid flow within the opening.

19. The fluid deflector of claim 17, wherein the fluid deflecting element having a generally pyramid cross-sectional shape, with a tip region pointing towards a fluid flow within the opening.

20. The fluid deflector of claim 17, wherein the fluid deflecting element being suspended adjacent to the one or more fluid sensors disposed within the opening.

21. The fluid deflector of claim 17, wherein the fluid deflecting element having an overall size based, at least in part, on a size of the opening.

22. The fluid deflector of claim 17, wherein the fluid deflecting element having an overall size based, at least in part, on an expected fluid flow within the opening.

23. The fluid deflector of claim 17, wherein the fluid deflecting element being suspended approximately in the center of the opening.
